(19) United States
(12) Patent Application Publication
(10) Pub. No.: US 2009/0140585 A1
(43) Pub. Date: Jun. 4, 2009

(54) INTERFACE CONNECTOR FOR A MOTOR AND A MOTOR INCORPORATING THE INTERFACE CONNECTOR

(76) Inventor: Albert Keith Pant, Carlisle, OH (US)

Correspondence Address: MICHAEL BEST & FRIEDRICH LLP, 100 E WISCONSIN AVENUE, Suite 3300, MILWAUKEE, WI, 53202, US

(21) Appl. No.: 12/263,771

(22) Filed: Nov. 3, 2008

Related U.S. Application Data
(60) Provisional application No. 60/991,387, filed on Nov. 30, 2007.

(51) Int. Cl. H02K 11/00

(52) U.S. Cl. 310/71

(57) ABSTRACT

An interface connector for use with an electric motor. The interface connector comprises a body made of insulating materials and conductors made of conducting materials. One side of the body has a plurality of recessed openings, and the conductors are imbedded in the body such that a conductor is individually located within a respective recessed opening, although there may be a greater number of recessed openings than conductors.

### RELATED APPLICATIONS

This application claims the benefit of U.S. Provisional Patent application No. 60/991,387, filed on Nov. 30, 2007, the content of which is incorporated by reference in its entirety.

### BACKGROUND

The invention relates to electrical connectors for interfacing power and/or signal conductors between a first apparatus and an electric motor.

In many cases, the electrical connection for an electric motor is a wiring harness (or “pigtail”) emerging from the motor housing through a grommet. Wiring connections of this type are disadvantageous in that the wires may become tangled or broken during installation of the motor. Additionally, the wiring harness is often attached to a circuit board within the motor enclosure. If the wiring harness becomes ensnared during installation, the wiring harness may become disconnected from the circuit board, ruining the motor.

### SUMMARY

In one embodiment, the invention provides an interface connector comprising a body and a plurality of conductors, each conductor having a tab end and a pin end. One side of the body has a plurality of recessed openings, and the conductors are partially embedded in the body such that the tab end of each conductor is located in a respective recessed opening. According to this embodiment, the pin ends protrude from another side of the body, thereby allowing the pin ends to be interfaced to a circuit board or some other means of making electrical connections. Because the body is made of an insulating material, each conductor remains electrically isolated from the other conductors.

In some embodiments, the motor interface connector has one or more slots molded into the body so that the interface connector receives mounting surfaces of first and second portions of a motor housing, wherein the first and second portions of the motor housing can be assembled to produce an enclosure for a motor. Optionally, the interface connector may be soldered to a circuit board. In the event the interface connector is soldered to a circuit board, the circuit board and interface connector may be disposed into a first portion of the motor housing, and then the circuit board, connector and first portion of the motor housing may be assembled with the second portion of the motor housing to make a complete enclosure for a motor. Thus, the enclosure for the motor can hold the interface connector securely in place with respect to the circuit board.

In another embodiment, the invention provides for an electric motor comprising an interface connector comprising a body and a plurality of conductors, each conductor having a tab end and a pin end. One side of the body has a plurality of recessed openings, and the conductors are partially embedded in the body such that the tab end of each conductor is located in a respective recessed opening. The electric motor may optionally have a circuit board contained inside a motor housing. The interface connector provides, in one implementation, a way to interface external power and control circuitry to the electric motor.

Other aspects of the invention will become apparent by consideration of the detailed description and accompanying drawings.

### BRIEF DESCRIPTION OF THE DRAWINGS

FIG. 1 is a perspective view of an embodiment of an interface connector of the invention.

FIG. 2 is a front view of the interface connector shown in FIG. 1.

FIG. 3 is a sectional view of the interface connector shown in FIG. 1.

FIG. 4 is a bottom view of the interface connector shown in FIG. 1.

FIG. 5 is a partial exploded view of a portion of a motor assembly, including the interface connector shown in FIG. 1.

FIG. 6 is a partial exploded view of a motor assembly, including the portion of the motor assembly shown in FIG. 5.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Although directional references (e.g., front, rear, behind, etc.) may be made herein in describing the drawings, these references are made relative to the drawings (as normally viewed) for convenience. These directions are not intended to be taken literally or limit the invention in any form. In addition, terms such as “first,” “second,” and “third” are used herein for purposes of description and are not intended to indicate or imply relative importance or significance.

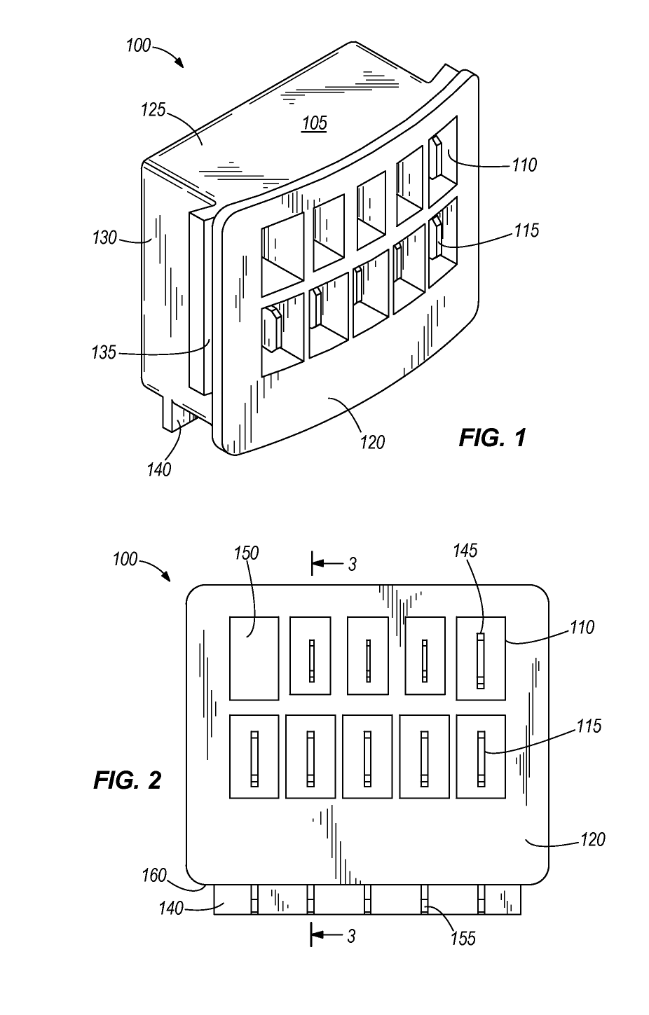

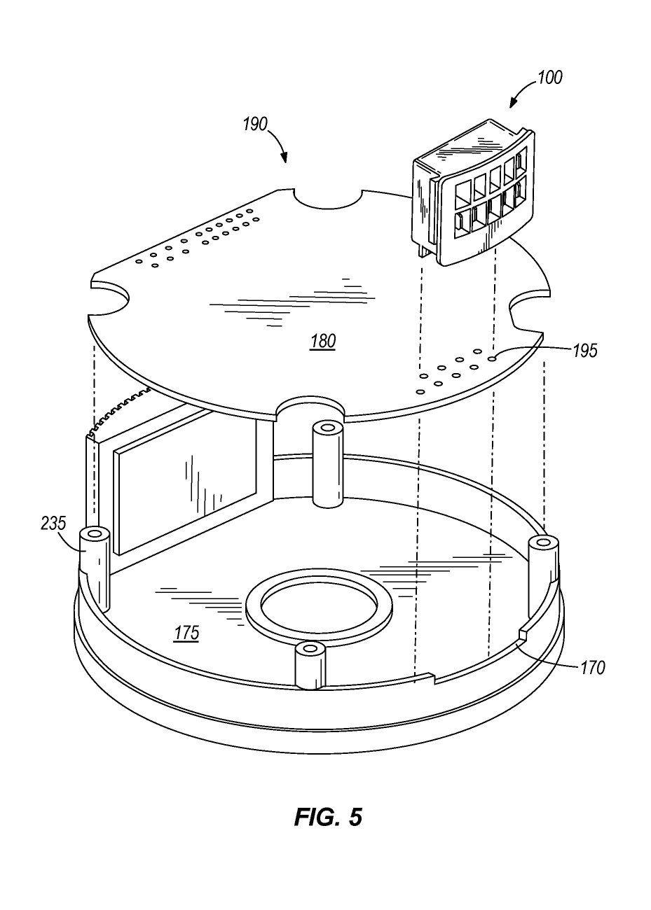

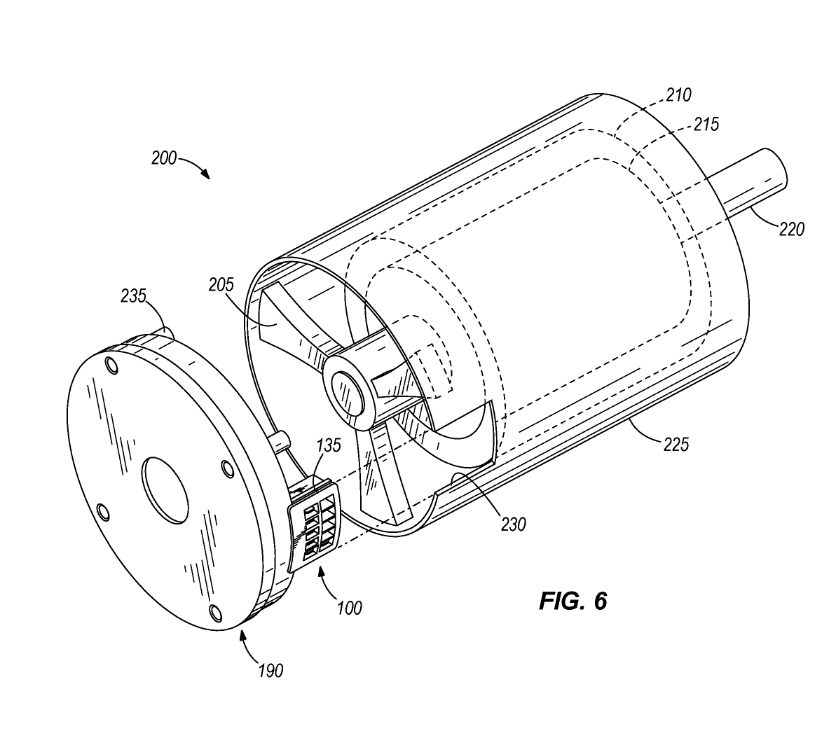

FIGS. 1 and 2 show an interface connector 100. Interface connector 100 is comprised of a body 105 with recessed openings 110, and conductors 115 partially embedded in body 105. Body 105 is a single contiguous piece in that it is not constructed from multiple pieces, but rather comprises a unitary piece of material. Body 105 may be constructed from insulating materials including, but not limited to, acrylonitrile butadiene styrene (ABS), polyethylene, polyvinyl chloride, nylon and polytetrafluoroethylene. Conductors 115 may be constructed from a number of conducting materials, including, but not limited to, copper, aluminum, and alloys comprising copper and aluminum. As shown in FIG. 1, interface connector 100 has a front 120, a top 125, and a side 130. Interface connector 100 may optionally have a slot 135 in side 130 such that body 105 receives into a mounting surface 230 (shown in FIG. 6) of a second portion 225 of a motor housing (shown in FIG. 6). Body 105 may also have a stand 140 to provide additional structural reinforcement once interface connector 100 has been attached to a circuit board 160 (shown in FIG. 5). Stand 140 may additionally assist in the location of interface connector 100 during assembly of an electric motor.

Recessed openings 110 are visible in front 120 of interface connector 100. According to the invention, tab ends 145 of conductors 115 are arranged within at least some of recessed openings 110. This arrangement allows tab ends 145 to be individually indexed to mate with protrusions from a mating connector having a plurality of conductor tab receptacles (not shown). Tab ends 145 may vary in size and shape for convenience or to assure that power connections and signal connections are not crossed. For example, tab ends 145 may be rectangular in shape, or have beveled edges, or may be rounded to mate with tab receptacles (not shown). A particular combination of tab end shapes and sizes may be advantageous in assuring that various power and/or control wiring is not crossed. Additionally, interface connector 100 may be produced with one or more of the recessed openings 110 without a tab end 145, thus creating a blank opening 150 which may act as a reference point for the mating connector, which may be substantially symmetric.

Conductors 115 additionally have pin ends 155, which are seen in FIG. 2 as protruding from a bottom 160 of interface connector 100. Pin ends 155 may be arranged in front of stand 140, as shown, or behind stand 140, or straddling stand 140 as the needs of interface connector 100 dictate. Pin ends 155, may comprise a variety of shapes and sizes, such as round, square, rectangular, or triangular, in order to mate each pin end 155 with the appropriate internal connection (not shown).

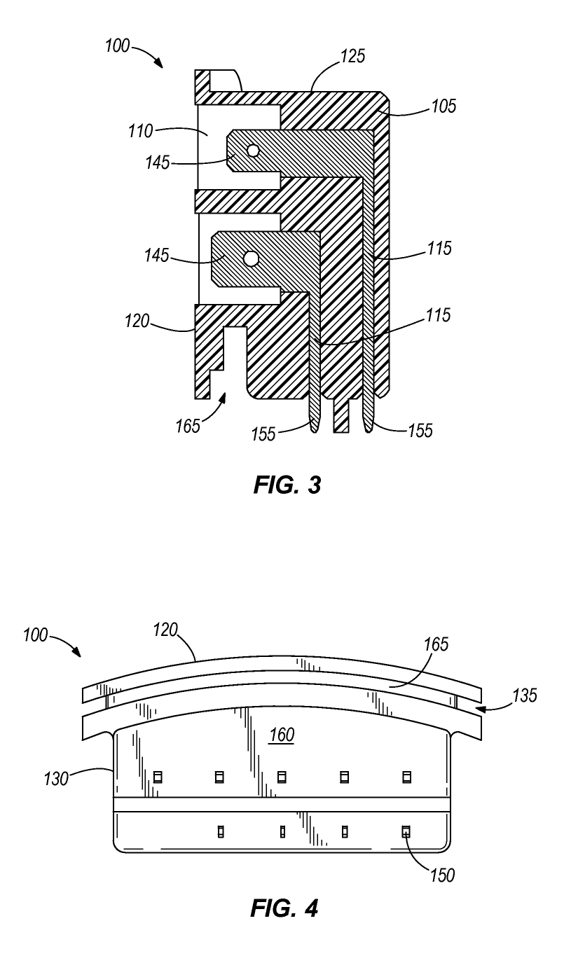

FIG. 3 is a sectional view of interface connector 100, taken along the cut-line 3-3 shown in FIG. 2. As can be seen in FIG. 3, body 105 holds conductors 115, providing insulation between conductors 115 and providing structural support. As shown in FIG. 3, conductor 115 is a continuous piece having tab end 145 and pin end 155. Tab ends 145 are connected to pin ends 155 that may be connected to a circuit board 180 (shown in FIG. 5). As shown in FIG. 3, conductors 115 may be substantially “L” shaped, however other shapes may be used as the arrangement of interface connector 100 require. Other shapes and designs for conductors 115 are possible. For example, conductor 115 may be “S” or “I” shaped depending upon the orientation of the final connection to pin ends 155. An additional slot 165 for receiving into a mounting surface 170 (shown in FIG. 5) in a first portion 175 (shown in FIG. 5) of a motor housing is also visible.

FIG. 4 is a view of bottom 160 of interface connector 100 and shows detail of pin ends 155. FIG. 4 also shows an optional configuration of stand 140, as well as additional slot 165 for receiving a mounting surface 170 (shown in FIG. 5) in a first portion 175 (shown in FIG. 5) of a motor housing. The curvature of the front 120 of interface connector 100 and additional slot 165 match the curvature of mounting surface 170 (shown in FIG. 5). Additional slot 165 need not be curved, and typically will be formed to match the shape of the motor housing. For example, additional slot 165 may be substantially straight if the motor housing is square.

FIG. 5 is a partial exploded view of a portion of a motor assembly 190, including interface connector 100, circuit board 180, and the first portion 175 of a motor housing. Interface connector 100 will typically be disposed upon circuit board 180, such that pin ends 155 align with holes 195 of circuit board 180. Pin ends 155 may be optionally soldered to circuit board 180 such that each pin end 155 is connected to the appropriate circuit on circuit board 180. Other methods of attaching pin ends 155 to circuit board 180 are known, such as glue, epoxy, or metal fasteners. In the event that interface connector 100 is disposed upon circuit board 180, circuit board 180 with attached interface connector 100 may be together disposed into first portion 175 of a motor housing, with care being taken that additional slot 165 in bottom 160 receives mounting surface 170. Stand 140 may be used to establish a minimum clearance between bottom 160 (not shown) and circuit board 180. Other equivalent techniques for assembling may be used, for example circuit board 180 may first be disposed into first portion 175 of a motor housing, and then interface connector 100 attached thereto.

FIG. 6 is a partial exploded view of a motor assembly 200 including portion of a motor assembly 190 shown in FIG. 5, a bottom bracket 205, a stator 210, a rotor 215, a shaft 220, and a second portion 225 of a motor housing. After bottom bracket 205, stator 210, rotor 215, and shaft 220 are disposed into second portion 225 of a motor housing, portion of the motor assembly 190 is attached to second portion 225 of a motor housing. Slots 135 receive a mounting surface 230 in second portion 225 of the motor housing, thus ensuring the mechanical stability of the interface connector 100. Portion of a motor assembly 190 may be attached to second portion 225 of the motor housing by way of fasteners extending through guide posts 235 of first portion 175 of a motor housing. However, other methods of attaching portion of a motor assembly 190 to second portion 225 of motor housing are known.

The motor interface connector of the invention can be used to provide an external interface for a control and/or power circuit of an electric motor. Interface connectors are typically used in electric motors that are incorporated into mechanical devices, including, but not limited to, furnaces, blowers, or pumps. Such motors are typically under 50 hp, preferably under 20 hp, more preferably under 10 hp. Motors incorporating the interface connector of the invention may be sold as part of a new mechanical device, or the motor may be sold as an aftermarket replacement for motors of similar size and power.

The interface connector allows an electric motor to have a streamlined profile, as there are no dangling connectors. This profile is especially beneficial when the motors are sold as aftermarket replacements because there are fewer concerns about wires being crimped or broken during shipping and installing. Additionally, motors incorporating an interface connector of the invention may be able to fit into tighter spaces, because there are no wires emerging from the motor housing.

Thus, the invention provides, among other things, a new and useful interface connector for a motor and a motor incorporating the interface connector.

What is claimed is:

1. An interface connector for a motor, comprising:
a body having a plurality of sides, the first side having a plurality of recessed openings; and
a plurality of conductors partially imbedded in the body, each conductor having a tab end and a pin end, the tab end being disposed in one of the plurality of recessed openings, and the pin end protruding from the second side.

2. The interface connector of claim 1, wherein the body is a unitary piece of material.

3. The interface connector of claim 1, wherein a third side and a fourth side of the plurality of sides includes a first slot and a second slot, respectively, the first slot and the second slot to receive a portion of a mounting surface.

4. The interface connector of claim 1, wherein each tab end is disposed in a respective recessed opening.

5. The interface connector of claim 1, further comprising a stand.

6. The interface connector of claim 1, wherein the first side having a plurality of recessed openings is contoured.

7. The interface connector of claim 1, wherein the number of recessed openings is greater than the number of conductors.

8. The interface connector of claim 1, wherein the body is constructed from an insulating material and each conductor is electrically isolated from the other conductors.

9. The interface connector of claim 8, wherein the insulating material is selected from the group consisting of acrylonitrile butadiene styrene (ABS), polyethylene, polyvinyl chloride, nylon and polytetrafluoroethylene.

10. The interface connector of claim 1, wherein the conductors are substantially “L” shaped.

11. The interface connector of claim 1, wherein the conductors are constructed from copper, aluminum, or an alloy comprising copper or aluminum.

12. An electric motor comprising the interface connector of claim 1.

13. The electric motor of claim 12, further comprising a housing having a contour and a mounting surface, wherein the interface connector is secured in place by the mounting surface.

14. The electric motor of claim 13, wherein the third side and the fourth side include a first slot and a second slot, respectively, the first slot and the second slot to receive a portion of the mounting surface.

15. The electric motor of claim 13, wherein the first side having a plurality of recessed openings is contoured to match the contour of the housing.

16. The electric motor of claim 12, wherein the body is a unitary piece of material.

17. The electric motor of claim 12, further comprising a circuit board operatively connected to the interface connector.

18. The electric motor of claim 17, wherein each pin end is received by a respective hole in the circuit board.

19. The electric motor of claim 18, wherein the interface connector further comprises a stand, the stand establishing a clearance between a side of the interface connector and the circuit board.

20. The electric motor of claim 12, wherein the number of recessed openings is greater than the number of conductors.

21. An interface connector for a motor, comprising:
a body that is a unitary piece of material, the body having a plurality of sides;
a plurality of substantially “L” shaped conductors partially imbedded in the body, each conductor having a tab end and a pin end;
the first side of the plurality of sides having multiple rows of recessed openings, the tab ends being disposed in the recessed openings;
the second side of the plurality of sides having the pin ends protruding therefrom;
the third side and the fourth side of the plurality of sides including a first slot and a second slot, respectively, the first slot and the second slot to receive a portion of a mounting surface.

22. The interface connector of claim 21, wherein the insulating material is selected from the group consisting of acrylonitrile butadiene styrene (ABS), polyethylene, polyvinyl chloride, nylon and polytetrafluoroethylene

23. The interface connector of claim 21, wherein the conductors are constructed from copper, aluminum, or an alloy comprising copper or aluminum.

24. The interface connector of claim 21, wherein each tab end is disposed in a respective recessed opening.

25. The interface connector of claim 21, wherein the number of recessed openings is greater than the number of conductors.
